(19) United States
(12) Patent Application Publication
(10) Pub. No.: US 2014/0265598 A1
(43) Pub. Date: Sep. 18, 2014

(54) PHOTOVOLTAIC AND WIND ENERGY PRODUCTION SYSTEM

(71) Applicant: Powerhouse Electrical Contractors Inc., Marianna, FL (US)

(72) Inventor: Vincent ISABELLA, Marianna, FL (US)

(73) Assignee: Powerhouse Electrical Contractors Inc., Marianna, FL (US)

(21) Appl. No.: 14/212,309

(22) Filed: Mar. 14, 2014

Related U.S. Application Data
(60) Provisional application No. 61/792,587, filed on Mar. 15, 2013.

(51) Int. Cl. F03D 9/00; H01L 31/04

(52) U.S. Cl. CPC F03D 9/007; H02S 10/00
USPC 307/72; 416/146 R

(57) ABSTRACT

A combined wind and photovoltaic solar energy production system is disclosed. One or more surfaces of the wind turbine blades are constructed of photovoltaic thin-film or have photovoltaic solar panels. Unlike prior art systems, in which photovoltaic material is placed on top of pre-existing wind turbine blades, the present application uses the photovoltaic material itself (e.g. the thin-film or solar panel) as the wind turbine blade. This makes for a simpler, light weight, and more cost-effective design. Multiple designs and embodiments are disclosed. The designs include vertical and horizontal axis pinwheel designs, paddle fan designs, paddle wheel designs, and tristar designs. Each of these designs may be combined. Cable support systems may be used to hold these designs to enable fast deployment and be an alternative where conventional solar and wind generators are unable to be installed because of topographical land issues or available real estate.

### CROSS-REFERENCE TO RELATED APPLICATIONS

The This application is based upon and claims priority to U.S. Provisional Patent Application Ser. No. 61/792,587, entitled “PHOTOVOLTAIC AND WIND ENERGY PRODUCTION SYSTEM”, filed Mar. 15, 2013, the contents of the disclosure of which is hereby incorporated by reference in its entirety.

### BACKGROUND OF THE INVENTION

The present invention generally relates to the field of renewable energy sources such as the wind and the sun.

In recent years, varying attention has been given to generating electricity from renewable, pollution-free, energy sources such as the sun, wind and water. To date, no single method has proved sufficiently cost effective to warrant large scale investment and implementation. Moreover, current systems are typically cumbersome to ship. Field installation and maintenance are often times complicated.

### SUMMARY OF THE INVENTION

A novel combined wind and photovoltaic solar energy production system is disclosed. One or more surfaces of the wind turbine blades are constructed of photovoltaic thin-film or have photovoltaic solar panels. Unlike prior art systems, in which photovoltaic material is placed on top of pre-existing wind turbine blades, the present application uses the photovoltaic material itself (e.g. the thin-film or solar panel) as the wind turbine blade. This makes for a simpler, light weight, and more cost-effective design. Moreover, the present application allows the panels to ship flat. The combined wind and photovoltaic solar production system is assembled at the job site.

The turbine blades turn in the presence of wind. The photovoltaic material produces electricity in the presence of light, such as sunlight. There are three modes of producing power as follows:
Sunlight and wind—During periods of wind in daylight, the system produces power through both wind and solar electric.
Sunlight and no wind—During periods of daylight without wind, the system produces power through solar electric.
Wind—During periods of wind without daylight (e.g. night or cloudy day), the system produces power by wind.

Power produced from the photovoltaic material disposed on the turbine blades is transmitted down the rotating shaft assembly of the wind turbine using a slip ring. Various materials including thin-film material for creating the solar cell on the wind turbine blades are contemplated. See online URL at Wikipedia.org search term Photovoltaic_cell#Materials, the teachings of which are hereby incorporated by reference in its entirety.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a bottom view of a vertical axis flat pinwheel wind turbine with photovoltaic panels and/or thin-film prior to assembly and folding;

FIG. 2 is a bottom perspective view of the vertical axis flat pinwheel wind turbine with photovoltaic panels and/or thin-film of FIG. 1 being assembled;

FIG. 3 is a top perspective view of a vertical axis flat pinwheel wind turbine with photovoltaic panels and/or thin-film of FIG. 2 mounted on a vertical axis;

FIG. 4 is a top view of a vertical axis pinwheel wind turbine with thin-film photovoltaic prior to assembly and folding;

FIG. 5 is a top view of a vertical axis pinwheel wind turbine with thin-film photovoltaic being assembled;

FIG. 6 is a top perspective view of a vertical axis pinwheel wind turbine with thin-film photovoltaic of FIG. 5 mounted on a vertical axis;

FIG. 6A is a more detailed view of the upper portion of the pole of FIG. 6;

FIG. 7 is a top view of a support for a vertical axis paddle fan wind turbine with photovoltaic panel blade;

FIG. 8 is a side view of a support for a vertical axis paddle fan wind turbine with photovoltaic panel blades;

FIG. 9 is a top view of a vertical axis paddle fan wind turbine with thin-film photovoltaic;

FIG. 10 is a side view of a vertical axis paddle fan wind turbine with thin-film photovoltaic blades of FIG. 9;

FIG. 11 is a top perspective view of a horizontal axis paddle wheel wind turbine with photovoltaic panel blades;

FIG. 12 is a top view of a horizontal axis paddle wheel wind turbine with photovoltaic panel blades or thin-film photovoltaic blades;

FIG. 13 is a side view of a horizontal axis paddle wheel wind turbine with photovoltaic panel blades or thin-film photovoltaic blades of FIG. 12;

FIG. 14 is a top perspective view of a tristar wind turbine design with thin-film photovoltaic;

FIG. 15 is a side perspective view of the tristar wind turbine design with thin-film photovoltaic of FIG. 14;

FIG. 16 is a side view of the tristar wind turbine design with thin-film photovoltaic of FIG. 14 deployed on supporting cables;

FIG. 17 is a side view of a power transfer mechanism; and

FIG. 18 is a perspective view of a deployment option of the various turbine designs described here using an intermodal (trucks, ships, and railroad cars) shipping container.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure and function. Further, the terms and phrases used herein are not intended to be limiting; but rather, to provide an understandable description of the invention.

The terms “a” or “an”, as used herein, are defined as one or more than one. The term “plurality”, as used herein, is defined as two or more than two. The term “another”, as used herein, is defined as at least a second or more. The terms “including and/or having”, as used herein, are defined as comprising (i.e., open language). The term “coupled”, as used herein, is defined as connected, although not necessarily directly. The term “wind turbine” or “wind power plant” is a device that converts kinetic energy from the wind, also called wind energy, into mechanical energy. The mechanical energy is used to produce electricity.

The exact size and dimensions of any of the examples discussed below is not important. The designs can be enlarged or reduced depending on application, power consumption needs, wind and solar conditions. Turbine designs that are shown oriented generally horizontal axis turbines can be turned to be oriented to vertical axis turbines, or vice-versa. Further, one or more of each design or multiple designs or orientations can be combined within the true scope of the present application.

### Vertical Axis Flat Pinwheel

FIG. 1 is a bottom view of a vertical axis flat pinwheel wind turbine with photovoltaic panels and/or thin-film prior to assembly and folding. Shown is the bottom side 101 of a substantially rectangular shape of material 100. The material 100 can be made from stamped metal, a composite, plastic, or a combination thereof. The material has to be malleable and bendable during installation. The material has four corners 116, 126, 136, 146, and substantially straight edges 110, 120, 130, 140. Radial lines 162, 164, 166, 168 from a center opening 102 to each corner 116, 126, 136, 146, are shown. A set of perforations 114, 124, 134, 144 runs for a given distance from each corner 116, 126, 136, 146 to a center opening 102. The perforations 114, 124, 134, 144 are approximately ⅓ the distance from the corner to the center opening 102. A set of cuts 118, 128, 138, 148 from each of the perforations in the set 114, 124, 134, 144 and to each of the edges 110, 120, 130, 140 adjacent to it is formed. Along the same line of each cut 118, 128, 138, 148 is a bend line 112, 122, 132, 142 running to the corresponding edge 110, 120, 130, 140. In one example, all the areas shown as shaded with item 133 are cut-outs to reduce the weight and material cost of the structure with thin-film 320.

The perforation 114, 124, 134, 144 is approximately a fifty percent perforation, i.e. fifty percent material and fifty percent voids. It is important to note that other percentages of perforations and lengths are contemplated within the true scope and spirit of the invention. A series of holes 163, 165, 167, and 169 are formed as shown and will be further described with reference to FIG. 2 below.

FIG. 2 is a bottom perspective view 200 of the vertical axis flat pinwheel wind turbine 100 with photovoltaic panels and/or thin-film of FIG. 1 being assembled. Each of the four corners 116, 126, 136, 146 is bent up in a substantially triangular shape wind blade as shown. More specifically, using corner 146 as an example, a field installer bends corner 146 upright along bend line 148. The field installer also bends along perforation 144 to the holes (not shown) to be at a right-angle with respect to holes 168 along edge 258. An L-shaped member 258 is fabricated from metal, composite, plastic or a combination thereof. The L-shaped member is securely fastened using fasteners such as fasteners, bolts, screws, rivets, adhesives, welds, extrusions, or a combination thereof, or other field-installable fasteners in order to join the bottom side 101 with holes 167 on the triangular shape to firmly keep the corner 146 in a vertical position. Each corner 116, 126, 136, 146 is bent up as shown along bend lines 128, 138, 148 and perforations 124, 134, 144 and held firmly in places with fasteners along an L-shaped member 264, 266, 268. A series of air scoops 272, 274, 276, 278 are formed from the thin-film and attached at to each corner support 116, 126, 136, 146 as shown.

It should be understood that this vertical axis flat pinwheel wind turbine with photovoltaic panels and/or thin-film design is easy to ship flat as shown in FIG. 1 and then field assembled with a minimum of tools and parts, as shown in FIG. 2. The complete assembly is now inverted with the corners 116, 126, 136, 146 with air scoops 272, 274, 276, 278 facing down towards earth. This is shown in FIG. 3 as a top perspective view 300. The center opening 102 is fixed to a power transfer mechanism 304 that will be described in further detail below with reference to FIG. 17. The power transfer mechanism 304 is fixed to a vertical support 310 and base 312. The power transfer mechanism 304 is fixed to top surface 382 and rotates on bearing that have a collar around an inner race of the bearing. Multiple fasteners are used to secure the power transfer mechanism 304 to the cylindrical support pipe 310.

A top surface 382 of the rectangular material 100 in one example thin-film solar 320 is disposed, laminated, glued or a combination thereof on the top surface 382. The thin-filmed solar 382 may disposed directly on the blades is at least one of crystalline silicon and thin films. The thin-film may be cadmium telluride, copper indium gallium selenide, gallium arsenide multijunction, light-absorbing dyes (DSSC), quantum dot solar cells, organic/polymer solar cells, silicon thin films, or a combination thereof. In another example, solar inks, such as DuPont™ Innovalight™ silicon inks and similar products may be applied to the top surface 382. In another example, the top surface has solar panels 320 affixed to it. The solar panels can be framed or frameless solar panels. In another example. In other examples, a combination of solar panels, thin-film, and solar inks are used.

It is important to note that additional support members may be attached to the bottom side 101 of the rectangular material 100 and to the combination wind turbine generator and rotating photovoltaic electric motor 304 during installation. They can be pre-constructed or preformed brackets/supports with holes and fasteners to line-up with the bottom side 101 of the rectangular material 100 on one end. On the other end, there are fasteners or preformed channels and mounts on the power transfer mechanism 304. This is important in larger geometries and/or heavier wind loads.

It is important to note that additional support members may be attached to the bottom side 101 of the rectangular material 100 and to the power transfer mechanism 304 during installation. They can be pre-constructed or preformed brackets/supports with holes and fasteners to line-up with the bottom side 101 of the rectangular material 100 on one end. On the other end, there are fasteners or preformed channels and mounts on the power transfer mechanism 304. This is important in larger geometries and/or heavier wind loads.

In another example, the solar panels may be made in other geometric shapes, such as triangular shapes, in order for cover more of the available surface area on the top surface 382 of the pin wheel 100.

### Vertical Axis Pinwheel

FIG. 4 is top view 400 of a vertical axis pinwheel wind turbine with thin-film photovoltaic prior to assembly and folding. Again shown is a substantially rectangular thin film solar panel 401 with four substantially straight edges 410, 430, 450, and 460. Here the solar thin-film material is printed or laminated between one or more transparent plastic sheet(s) 401 that is weather resistant, UV resistant, and at the same time, allows wave-lengths of light for photovoltaic generation to pass through with minimum loss. There are multiple substantially triangular shaped regions of photovoltaic thin-film solar material 442, 444, 446, 448 that are disposed on the top side of thin film solar panel 403. The thin-film may be cadmium telluride, copper indium gallium selenide, gallium arsenide multijunction, light-absorbing dyes (DSSC), quantum dot solar cells, organic/polymer solar cells, silicon thin films, or a combination thereof. In another example, solar inks, such as DuPont™ Innovalight™ silicon inks and similar products may be applied to the plastic sheet(s) 401. The thin film solar laminated to the rectangular material at the factory. The thin film is manufactured in the factory in a substantially rectangular sheet Note: only the flat pinwheel may have the thin film panel adhered to the skeletal frame during the field installation. All other windmill designs have the frames attached to the thin film panels at the factory, they are shipped flat then assembled in the field into a windmill structure.

It is important to note that the triangular shaped regions are just examples. Other geometric shapes and combinations are contemplated within the present invention. Also shown is center opening 402 with a grommet 490 formed in the plastic sheet(s) 401, this is attached to a power transfer mechanism 604 as shown in FIG. 6.

Holes 422, 424, 426, 428 with grommets 492, 494, 496, 498 are formed near each of the four corner regions 482, 484, 486, 488. Four cuts 462, 464, 466, 468 in the plastic sheet(s) 401 from each corner 482, 484, 486, 488 towards the center opening 402 are also formed. The length of each cut 462, 464, 466, 468 is 50-90 percent of the distance between the center opening 402 and each the corner regions 482, 484, 486, 488.

FIG. 5 is top view 500 of a vertical axis pinwheel wind turbine with thin-film photovoltaic of FIG. 4 being assembled in the field. To begin, each of the holes 422, 424, 426, 428 with grommets 492, 494, 496, 498 are placed on a center position or axis 502 as shown from a position in a common plane of the thin film solar panel 401. A section of the plastic sheet(s) 401 on one side of the cuts 462, 464, 466, 468 forms an edge 532, 534, 536, 538 as shown. An edge stiffener 562, 564, 566, 568 is mechanically coupled on each edge 532, 534, 536, 538. Each stiffener 562, 564, 566, 568 can be made of metal, plastic, composite, or a combination thereof. The purpose of each stiffener 562, 564, 566, 568 is to keep the shape of the edge 532, 534, 536, 538 straight and not buckle or deform overtime or in high wind. Each edge 532, 534, 536, 538 can be clipped in with fasteners such as adhesive, screws, bolts, pins, or fabricated with a groove to slide over the edge 532, 534, 536, 538 similar to pieces of plastic edging/molding used with wood paneling. In one example, portions of the plastic sheet 401 include areas which are transparent to sunlight. This allows sunlight to pass-through upper portion of the pinwheel into interior regions.

FIG. 6 is a top perspective view 600 of a vertical axis pinwheel wind turbine with the thin-film photovoltaic of FIG. 5 mounted on a vertical support 610. The ring 490 is supported by an upper portion 602 of the pole 610. This is elevated so that the slip ring wiring travels from the thin-film to the power transfer mechanism 504.

As described with reference to the vertical axis flat pinwheel wind turbine with photovoltaic panels and/or thin-film in FIGS. 1-3 above, it is important to note that additional support members may be attached to the bottom side 405 of the plastic sheet(s) 401 and to the combination wind turbine generator and rotating photovoltaic electric motor 604 during installation. They can be pre-constructed or preformed brackets/supports with holes and fasteners to line-up with the bottom side 405 of the rectangular material 100 on one end. On the other end, there are fasteners or preformed channels and mounts on the power transfer mechanism 604. This is important in larger geometries and/or heavier wind loads.

Vertical Axis Paddle Fan with Frameless Glass Photovoltaic Panel Blades

FIG. 7 is a top view of a support 700 for a vertical axis paddle fan wind turbine with photovoltaic panel blades 750. Shown is a substantially I-shaped frame 705. The I-shaped frame 705 can be made from metal, plastic, composite, or a combination thereof. A triangular shaped mount 702 with three side faces 740, 742, 744 is shown. Each side face 740, 742, 744 has a plurality of holes 816 to mechanically coupled to a center frame member 804 to a first end frame member 710 of the I-shaped frame 705. The triangular center mount 702 is mechanically coupled to a power transfer mechanism 804. It is important to note that other shape frames including rectangular are contemplated within the true scope of the present invention. The various frame members 710, 720, 730 are coupled together using one or more fasteners, bolts, screws, rivets, adhesives, welds, extrusions, or a combination thereof. A series of holes 714 and 724 are used to mount to the I-shaped frame 705 is a photovoltaic solar panel 750. The photovoltaic solar panel 750 itself becomes the blade for wind turbine rather than having a separate blade.

FIG. 8 is a side view 800 of a vertical support 810 for a vertical axis paddle fan wind turbine with a frameless glass photovoltaic panel blade 750 of FIG. 7. Shown is the power transfer mechanism 704. It is important to note that in one example the mount 702 is tilted slightly like a blade of a ceiling fan capture wind from a horizontal direction or direction normal to the vertical support 810. Two or more blades constructed as shown in FIG. 7 may be power transfer mechanism 804. The number of blades attached is based on various anticipated factors. Likewise, the shape of polygon 702, shown as triangular shape would change to accommodate the number of blades. These factors include the amount of wind and the geometry and/or size of the system.

Vertical Axis Paddle Fan with Thin-Film Photovoltaic Blades

FIG. 9 is a top view 900 of a vertical axis paddle fan wind turbine with thin-film photovoltaic blades 905. Shown is a substantially rectangular-shaped frame 910. It is important to note that other geometric shapes are possible within the true scope of the present application. The frame 910 can be made from metal, plastic, composite, or a combination thereof. A triangular shaped mount 902 with three side faces 940, 942, 944 is shown. Each side face 940, 942, 944 has a plurality of holes 1016 to mechanically coupled to a center frame member 1004 to a first end frame member 912 of the substantially rectangular-shaped frame 910. It is important to note that other shape frames including rectangular are contemplated within the true scope of the present invention. A substantially triangular mount 902 with a plurality of holes 1016 is mechanically coupled to the rectangular-shaped frame 905. Optional struts or stabilizers 1022, 1024 are also shown. The rectangular-shaped frame 910 holds a thin-film photovoltaic 950. The rectangular-shaped frame 910 can act like a picture frame with a rectangular void in the center. The rectangular void is covered with the thin-film photovoltaic 950 is firmly held taught. In another example, the rectangular-shaped frame 910 has a top portion and similarly shaped bottom portion (not shown). The thin-film photovoltaic 950 is sandwiched between the top portion and the bottom portion and is firmly held taught, like a piece of glass in window frame. The two sections of frames can be held together using fasteners, snaps, screws, bolts, welds, glue or a combination thereof. In each of these examples, the frame 910 (whether one part or two) along with the thin-film photovoltaic 950 can be assembled at the factory for easy installation and maintenance in the field. As with blades in a ceiling fan, these can ship flat and be attached together in the field. The thin-film photovoltaic 950 and frame 905 together form the blade for wind turbine rather than having a separate blade.

FIG. 10 is a side view 1000 of a vertical support 1010 for a vertical axis paddle fan wind turbine with thin-film photovoltaic 950 of FIG. 9. Shown is power transfer mechanism 1004. It is important to note that in one example the mount 902 is tilted slightly like a blade of a ceiling fan to capture wind from a horizontal direction or direction normal to the vertical support 1010. Two or more blades constructed as shown in FIG. 9 may be attached to the power transfer mechanism 1004. Likewise, the shape of polygon 902, shown as triangular shape would change to accommodate the number of blades. The number of blades used would be based upon the anticipated wind and the geometry and size of the system.

Horizontal Axis Paddle Wheel with Frameless Glass Photovoltaic Panel Blades or Thin-Film Photovoltaic Blades

FIG. 11 is a top perspective view of a horizontal axis paddle wheel wind turbine with photovoltaic panels 1100. Shown are three photovoltaic panel blades 1145, 1155, 1165 mechanically fastened to a pair of substantially Y-shaped mounts 1192, 1192 are each end 1102, 1104. The Y-shaped mounts 1192, 1194 are fastened to a common horizontal shaft 1110 mechanically coupled to a power transfer mechanism 1104 being held by a U-shaped frame 1170. It is important to note that other numbers of photovoltaic panels forming less than three sides or more than three sides can be used. Each of the photovoltaic panel blades 1140, 1150, 1160 is held by a frame 1105. For example for photovoltaic panel blade 1140, the frame 1105 includes at least a first side 1110 and a second side 1120 to hold the photovoltaic panel 1150. In other examples, the frame 1105 may include a top portion 1112 and a bottom portion 1122 as well. Each portion of the frame 1105 may include one or more slots (not shown) to allow edges the photovoltaic panel blade 1140 to fit firmly therein. Fasteners (not shown) such as bolts, screws, adhesive, or combination thereof may be used to further hold the photovoltaic panel blade 1140 into the frame 1105. In another example, each photovoltaic panel blades 1145, 1155, 1165 includes a second photovoltaic panel disposed back-to-back to the first photovoltaic panel to enable the capture of photoelectric energy on both sides of the panel blade.

FIG. 12 is a top view of a horizontal axis paddle wheel wind turbine with photovoltaic panel blades or thin-film photovoltaic blades 1200. Shown are two photovoltaic panel blades 1140, 1160 around a common horizontal shaft 1110 mechanically coupled to a power transfer mechanism 1194. It is important to note that other numbers of photovoltaic panels less than three or more than three can be used. Each of the photovoltaic panel blades 1140, 1150, 1160 is held by at least two portions of a frame 1110, 1120. Optionally, two other frame member may be used 1112 and 1122 to form an entire frame around the photovoltaic panel blades 1140, 1150, 1160. Also shown are struts or supports 1170, 1172, 1174 between each of the panel assemblies to provide additional strength depending on geometries, relative sizes of the blades and anticipated wind loads.

Turning to FIG. 13, shown is a side view 1300 of a horizontal axis paddle wheel wind turbine of FIG. 12. The two frame parts 1110 and 1120 hold firmly in place the photovoltaic panel or photovoltaic thin-film 1140 therebetween. The two frame parts 1110 and 1120 may be made from metal, plastic, composite or a combination thereof. Fasteners (not shown) such as bolts, screws, glue, or combination thereof may be used to further hold the photovoltaic panel blade 1140 into the frame 1110, 1220.

In another example, each photovoltaic panel blade 1140, 1150, 1160 includes a second photovoltaic panel disposed back-to-back to the first photovoltaic panel to enable the capture of photoelectric energy on both sides of the panel blade.

FIG. 13 is a side view of a horizontal axis paddle wheel wind turbine with photovoltaic panel blades or thin-film photovoltaic blades of FIG. 12. The Y-shaped mounts 1192 is shown fastened to each of the photovoltaic panel blades 1145, 1155, 1165 and mechanically coupled to the central common axis 1110.

Tristar with Thin-Film Photovoltaic Blade

FIG. 14 is a top perspective view of a tristar wind turbine design with thin-film photovoltaic 1400. In this example, there are two end support structures 1492, 1494 mechanically coupled together by a rotatable shaft 1410. A power transfer assembly 1480 is mechanically coupled to the shaft 1410. Substantially rectangular thin-film solar panels 1492, 1494, 1496 disposed on a flexible material such as a metal, plastic, composite, or combination thereof, are flexed into a slight arc and held firmly together by their longer edges 1432, 1434, 1436. The longer edges 1432, 1434, 1436 are held together at a common endpoint in one example using a piano hinge-type coupling assembly 1462, 1455, 1465. In another example the longer edges 1432, 1434, 1436 are held together using a U-shaped clasp or other fasteners, such as bolts, screws, rivets, adhesives, welds, extrusions, a combination thereof. Or the thin film can be 1 continuous panel with perforations or folding crease marks equally spaced into 3 parts along the long edge of the panel shipped flat then folded and fastened to the 2 triangular shaped supports during the field installation. This allows simple field installation and maintenance. The thin-film solar panels 1492, 1494, 1496 may be shipped flat. Adjacent sides of each of the support structures 1492, 1494 form a common point or support arms 1420, 1422, 1424. These support arms 1420, 1422, 1424, on each support structure 1492, 1494, are joined together hold the piano-hinge-type coupling assembly 1462, 1455, 1465 in place. The support structures 1492, 1494 radiates outward with approximately 120 degree angle between each of the support arms 1420, 1422, 1424. This forms a substantially tristar shape as shown. The support structures 1492, 1494 are mechanically coupled to a common vertical shaft 1410. The number N of sides rectangular thin-filmed solar panels can change from three or more sides or less than three sides depending on various anticipated factors like wind, weight, and geometry of the system. Likewise, number N of the polygon support structures 1492, 1494 would change to correspond to the number of thin-filmed solar panels. These factors include the amount of wind and the geometry and/or size of the system.

A series of one or more openings 1447 is formed in each thin-film solar panels 1492, 1494, 1496 near their longer edge. Air flowing over the thin-film solar panel 1445 enters these opening 1447 and pushes against an interior side 1467 of thin-film solar panels 1494.

This tristar structure 1400 is lightweight. This greatly reduces manufacturing, shipping, and installation costs. No separate mounting structure or ballast is needed to mount the panels. The thin-film solar may be cadmium telluride, copper indium gallium selenide, gallium arsenide multijunction, light-absorbing dyes (DSSC), quantum dot solar cells, organic/polymer solar cells, silicon thin films, or a combination thereof. In another example, solar inks, such as DuPont™ Innovalight™ silicon inks and similar products may be applied to metal, plastic, composite, or combination of substrates to form the wind turbine blade.

### Tristar Deployment on Cables

FIG. 16 is a side view of the tristar wind turbine design 1600 with thin-film photovoltaic of FIG. 14 deployed on supporting cables 1620, 1630, 1624, 1634. Shown are six 1684, 1686, 1686, 1690, 1692, 1694, 1694, 1696 tristar assemblies of FIGS. 14 and 15. The lower end of each of these tristar assemblies are mechanically coupled to a bottom support cable 1630, 1634 though a short section of cylindrical pipe support rotatably attached to the tristar assembly as one end and the other end of the cylindrical pipe support mechanically coupled to fixed non-rotating mount to the lower cable (not shown). The upper end of tristar assemblies is attached to the inner race of the bearing of the power transfer mechanism 1680 and the other end affixed to the upper or top cables 1620, 1624. In one example, the top rotatable coupling assembly is a power transfer mechanism 1680, such as 1480 shown in this FIG. 14. In another example, the power transfer mechanism is on the bottom. The top support cable 1620, 1622 and bottom support cable 1630, 1632 are held substantially horizontal by being mechanically coupled to right support pole 1640 and left support pole 1650. Additional cables and supports may be need to stabilize the assembly depending on relative sizes, distance, geometries, and anticipated wind loads. This deployment configuration 1600 allows easy addition and subtraction of tristart units in the field to meet the required power density. Also, in case of storms, such as hurricanes, this deployment of tristar units can be quickly collapsed by moving one or more of the right support pole 1640 and left support pole 1650. In another example a setup similar to a sky trolley or chairlift retrieval system or an up and down pulley system similar to that of a flag pole may be incorporated into this design to enable fast and easy retrieval, deployment, or storage.

Other designs above such as those shown in FIGS. 1-13 can be mounted on a cable system with the power transfer mechanism motor on the bottom & stabilizer wire on top connecting to the top of the vertical mast of a plurality of pinwheels with a swivel bearing & tension coil spring.

### Power Transfer Mechanism

FIG. 17 is a side view of a power transfer mechanism 1700. The design provides many advantages. First, for mounting with a horizontal axis or vertical axis wind turbine for transferring by the rotating wind energy. Second, for transferring photovoltaic energy from photovoltaic blades of the wind turbine. Third, allow simple field installations for the designs shown above to a fixed horizontal axis or vertical axis mount.

Starting from the top, shown is a slip ring 1702 or commutator is electrically coupled to a set of feed wires 1780 and to wires 1750 running towards the bottom. A mounting surface 1704 for mechanically coupling to the center regions or mounts of the designs above, e.g. 102, 402, 702, 902, 1102, 1202, 1402. A shell 1728 is rotatably mounted on bearings 1722, 1724, and 1742 fastened to shaft 1726. Feed wires 1780 run through an opening near the shaft 1726 to carry power away from the solar panels turbine blades. A set of optional support bracket/arms (not shown) may also be mechanically attached to shell 1728. The purpose of these support brackets/arms is hold the combination wind turbine and photovoltaic blades for larger installation geometries and/or heavy wind loads. A set of holes 1704, 1706 for fasteners (not shown) are used to firmly attach to the combination wind turbine and photovoltaic blades. A slip ring 1742 or commutator is electrically coupled to a set of feed wires 1780 and to wires 1750 running towards the bottom. These wires carry power from the photovoltaic blades of the wind turbine. The slip ring 1742, such as a Mercotac, allows power to be transferred from the rotating wind turbine down to a set of wires 1750 attached to 1752 fixed support 1752. One or more gears or a transmission is mechanically coupled the shell 1728 to drive electrical generator 1748. The electrical generator 1748 produces DC power over lines 1762 to an optional inverter 1760 to convert DC power to AC power. A quick disconnect interface is also contemplated to make electrically connecting the entire power transfer mechanism 1700. Likewise, depending on the application, DC may be output and combined with other photovoltaic and wind energy production system. Likewise, the wires 1762 carrying DC power from the photovoltaic to convert to an optional micro-inverter 1760 to convert DC power to AC power. Depending on the application, DC may be output and combined with other photovoltaic and wind energy production system. The power produced by the photo voltaic and/or the power produced by the generator can be wired in series for an inverter, series/parallel for a battery charge controller of tied to a micro inverter working synchronously with the wind generator. Inverters, micro inverters, charge controllers, and battery banks are all sized according to the specific designed use.

A mechanical coupling 1770 is used to mount the entire power transfer mechanism 1700 to a fixed horizontal or vertical support depending on the wind turbine used. The mechanical coupling 1770 can be held in place with a plurality of fasteners, screw, bolts, for easy installation, maintenance, or temporary removal of the unit in case of impending severe weather.

### Deployment Option

FIG. 18 is a perspective view of a deployment option of the various turbine designs described here using an intermodal (trucks, ships, and railroad cars) shipping container 1800. The container 1802, typically fabricated from steel has one or more doors 1804, and a bank of batteries 1810 for storing power. Cooling and ventilation such as a fan or air conditioning unit 1808 is shown. An inverter and wiring assembly to convert DC to AC power is embedded in the container 1802. In another example, the container 1802 includes additional amenities to enable self-sustaining deployment includes, but is not limited to, sleeping quarters, working quarters, food storage, cooking facilities, water storage, bath or shower facilities, and waste handling facilities.

The tristar wind turbine design 1600 of FIG. 16 is shown deployed on cables between mounting poles 1842, 1844, 1846, 1848 and 1832, 1834, 1836, 1838. The mounting poles and cables can be stored inside container 1802 during transport. Mounting poles 1832, 1834, 1836, 1838 are shown to be mechanically fastened to the top 1816 of the container 1802. This deployment configuration 1800 allows easy shipping, storage, transport tristar units in the field to meet the required power density. Also, in case of storms, such as hurricanes, this deployment of tristar units can be quickly collapsed.

Other designs above such as those shown in FIGS. 1-14 can be mounted on a cable system with the power transfer mechanism motor on the bottom & stabilizer wire on top connecting to the top of the vertical mast of a plurality of pinwheels with a swivel bearing & tension coil spring.

### Non-Limiting Examples

Although the present application has been described in relative terms of size and shape of the components, other components of different sizes and shapes are within the true scope. The scope of the invention is not to be restricted, therefore, to the specific embodiments, and it is intended that the appended claims cover any and all such applications, modifications, and embodiments within the scope of the present invention.

The size of the combination wind turbine and solar depends on the application. Sizes will range from 2′-8′ diameter. Camping, boating, street lights, billboard signs, residential, commercial, industrial, solar-wind farms, agricultural, military, off-grid, developing countries and remote construction are all possible uses. Solar & wind output rating will be dependent upon size of solar panels & wind generator as it relates to the size of the designs described herein.

What is claimed is:

1. A combination wind and photovoltaic solar energy production system, the system comprising:
a wind turbine with one or more blades formed from at least one a photovoltaic material attached to rotating assembly with a shaft for rotating about an axis, the photovoltaic material including at least one of a photovoltaic panel forming the blades and a photovoltaic thin-film disposed directly on the blades; and
a slip-ring mechanically coupled to the shaft, and the slip-ring electrically coupled to the photovoltaic material.

2. The combination wind and photovoltaic solar energy production system of claim 1, wherein the one or more blades formed includes an I-shaped support for holding the photovoltaic panel.

3. The combination wind and photovoltaic solar energy production system of claim 1, wherein the one or more blades formed includes a substantially rectangular-shaped frame defining a rectangular void, the photovoltaic thin-film held by the frame to substantially fill the void.

4. The combination wind and photovoltaic solar energy production system of claim 1, wherein the wind turbine is a horizontal axis turbine.

5. The combination wind and photovoltaic solar energy production system of claim 2, wherein the wind turbine is a vertical axis turbine.

6. The combination wind and photovoltaic solar energy production system of claim 1, further comprising:
an electrical generator mechanically coupled to the shaft, whereby when the shaft turns the electrical generator generates electricity.

7. The combination wind and photovoltaic solar energy production system of claim 1, wherein the photovoltaic thin-film disposed directly on the blades is at least one of crystalline silicon and thin films.

8. The combination wind and photovoltaic solar energy production system of claim 1, wherein the photovoltaic thin-film are at least one of cadmium telluride, copper indium gallium selenide, gallium arsenide multijunction, light-absorbing dyes (DSSC), quantum dot solar cells, organic/polymer solar cells, and silicon thin films.

9. A combination wind and photovoltaic solar energy production system, the system comprising:
a substantially rectangular sheet of material with four corner regions, with a top side and a bottom side, wherein each corner region includes a cuts bending of the corner to from a position in a plane with the material to a center position thereby forming a pinwheel, and
at least one region of photovoltaic thin-film disposed on at least one of the top side and the bottom side of the material.

10. The combination wind and photovoltaic solar energy production system of claim 9, wherein the at least one region of photovoltaic thin-film is disposed both on the top side and the bottom side.

11. The combination wind and photovoltaic solar energy production system of claim 10, wherein the at least one region of photovoltaic thin-film is transparent to allow sun-light to pass there through to other interior regions with photovoltaic thin-film disposed thereon.

12. A combination wind and photovoltaic solar energy production system, the system comprising:
a first polygon support structure with three or more sides and a second polygon support structure with an identical number of sides as the first polygon support structure, each adjacent side of the first support structure and second support structure forming an common endpoint therebetween;
a shaft mechanically coupled to the first polygon support structure and the second polygon support structure; and
a set of N substantially rectangular thin-film solar panels, where N is equal to the number of sides of the first polygon support structure, each of the substantially rectangular thin-film solar panel being held in between the first polygon support structure and the second polygon support structure around the shaft and substantially an entire edge of adjacent rectangular thin-film solar panels are held together with a fastener.

13. The combination wind and photovoltaic solar energy production system of claim 12, wherein the at least one of the substantially rectangular thin-film solar panels has a one or more openings formed therein near the edge being held with the fastener.

14. The combination wind and photovoltaic solar energy production system of claim 12, wherein the fastener is at least one of a pin and hinge, fasteners, bolts, screws, rivets, adhesives, welds, extrusions, or a combination thereof.

15. The combination wind and photovoltaic solar energy production system of claim 12, wherein the substantially rectangular thin-film solar panels are formed by applying silicon inks applied to metal, plastic, composite, or combination thereof.

16. The combination wind and photovoltaic solar energy production system of claim 12, wherein the thin-film solar panels are formed from at least one of cadmium telluride, copper indium gallium selenide, gallium arsenide multijunction, light-absorbing dyes (DSSC), quantum dot solar cells, organic/polymer solar cells, silicon thin films, or a combination thereof.

17. The combination wind and photovoltaic solar energy production system of claim 12, further comprising:
a top cable attached to a top rotating coupling assembly to the first polygon support structure; and
a bottom cable attached to a bottom rotating coupling assembly to second polygon support structure.

18. The combination wind and photovoltaic solar energy production system of claim 12, further comprising
a power transfer mechanism with a generator to convert energy from the shaft when rotating into electricity.

19. The combination wind and photovoltaic solar energy production system of claim 18, further comprising a fixed non-rotating mount and the power transfer mechanism includes a slip ring to transfer power produced by the thin-film solar panels to one or more wires fastened to the fixed non-rotating mount.

20. The combination wind and photovoltaic solar energy production system of claim 19, further comprising:
an inverter to convert DC power to AC power.
